(19) United States
(12) Patent Application Publication
(10) Pub. No.: US 2005/0062726 A1
(43) Pub. Date: Mar. 24, 2005

(54) Dual display computing system

(76) Inventors: Randal J. Marsden, Edmonton (CA); Clifford A. Kushler, Lynnwood, WA (US)

Correspondence Address: BLACK LOWE & GRAHAM PLLC, Suite 4800, 701 Fifth Avenue, Seattle, WA, 98104, US

(21) Appl. No.: 10/944,450

(22) Filed: Sep. 18, 2004

Related U.S. Application Data
(60) Provisional application No. 60/504,345, filed on Sep. 18, 2003.

(51) Int. Cl. G09G 5/00

(52) U.S. Cl. 345/173; 345/174

(57) ABSTRACT

A method and system of the present invention are distinguished by the fact that graphical elements can be displayed to a communication partner to enhance communication beyond words and synthesized speech. Extensive research in the field of augmentative communications has focused on using graphical elements, such as pictures and icons, to help a non-vocal user encode a message quicker than typing it letter-by-letter. But in spite of the well-known axiom “a picture's worth a thousand words”, none of these techniques have thought to use pictures, animations, video, or other graphical elements to output the message as well. The present invention corrects this oversight by providing two touch-sensitive, graphical, dynamic displays: one for the operator and one for the interlocutor (communication partner).

### FIELD OF THE INVENTION

This invention relates generally to Alternative Augmentative Communication (AAC) and, more specifically, to AAC devices.

### BACKGROUND OF THE INVENTION

Over 400,000 people in North America are unable to speak using their own voice. Starting in the mid 1970's, electronic devices have been invented that assist these people to communicate with those around them. The term “Alternative Augmentative Communication” (AAC) was coined to describe these type of devices.

A number of communication paradigms have been devised over the years that involve symbols, pictures, photographs, text, or a combination of any of these. Summers (U.S. Pat. No. 3,651,512) first described a system aimed at using technology to help people communicate who were unable to speak themselves. Because whatever disability is affecting a person's speech abilities usually also affects other neuromuscular functions, Summers describes an interface to the device involving four switches which are used to direct a selection light between possible message choices. Watts (U.S. Pat. No. 3,771,156) later improved on this design by reducing the number of switches required to control a similar device from four to one.

Originally, AAC devices had a fixed keypad containing the symbols or letters that the user interacted with to compose a communication. Later, dynamic displays with touch screens were developed. Most devices on the market today are made up of a single dynamic display with a touch screen. However, these systems are oriented towards the person operating the device, thus making it difficult for face-to-face communication.

In comparison to the speed at which spoken conversation usually takes place, it takes considerable time to compose a message to be conveyed by means of an AAC device. Often, a communication partner will look over the shoulder of the user to try and guess what the user is composing. Some users like this, others do not. Soon, the communication partner is caught up in the technology of the device and often ceases to communicate directly with the user. Many times the communication partner is not facing the user when speaking to them, but rather is looking over the user's shoulder.

Many techniques have been described that are aimed at making the encoding of a desired message more efficient. Baker et al. (U.S. Pat. No. 4,661,916) devised a system that makes use of a plurality of symbols, each of which can represent more than one meaning. This reduces the number of symbols required to be presented on a device at one time while still allowing for a broad range of messages to be encoded. Higginbotham (U.S. Pat. No. 5,956,667), Baxter (U.S. Pat. No. 6,128,010), Dynavox Corp. (in various commercially available devices), and Baker (U.S. Pat. No. 6,160,701) each describe various improvements to methods and systems for producing augmentative communication. All of these techniques pre-suppose a system with a single display with which the user interacts to compose a message, the output of which is text, synthesized speech, or both. No thought has been given to outputting graphical elements in addition to, or instead of, speech and text to enhance communication.

Further, with these conventional single-display systems, the communication partner most often ends up standing behind the operator and looking over their shoulder as they compose the message. This eventuality not only eliminates the possibility of face-to-face communication and the important human interaction that goes with it, but also results in the communication partner trying to “guess” what the operator is composing—the AAC equivalent of finishing someone else's sentence for them.

With the advent of portable display and touch-screen technology, many devices have been designed to be used by the operator in a mobile environment. In most cases, these computers have a single display with which the operator interacts. Limited attention has been given to devices that use two displays: one for the operator and another for a communication partner. Haneda et al. (U.S. Pat. No. 5,900,848) describe a system with two displays that can be positioned in three different configurations with corresponding adjustment to the backlighting of each display to reduce heat build-up. This system is intended for text translation, with text of one language appearing on one screen, and translated text of a second language on the other screen. Lin (U.S. Pat. No. 6,094,341) builds on this design by describing a method for adjusting the tilt of the second display. These techniques do not envision or encompass ways for people with disabilities to access them, or use them for augmentative communication. They also don't address the use of graphics as a part of what is being displayed on the Operator screen.

There are presently two devices on the market that employ dual-displays and that are intended for augmentative communication (see FIGS. 4 and 5). These are the “Dialo” from Possum Controls and the “LiteWriter” from Toby Churchill. In both cases, text is entered by the user on an integrated letter-based keyboard with the resulting text displayed on both the operator display and the partner display simultaneously. In the case of the Dialo, the message can also be spoken by an integrated speech synthesizer. Neither product is able to display graphical elements, nor are their displays interactive. Further, they require the user to be literate.

The present invention seeks to improve on these shortcomings by providing a system in which non-vocal individuals can communicate with others by outputting graphics on a second, partner-oriented display, in addition to text and speech. There exists a need to display graphics to communicate emotions and ideas more quickly and and with greater immediacy and impact than displayed text or synthesized speech alone. Further, there is a need to enable a communication partner to interact with the operator and the system via a touch-sensitive input screen on the partner-oriented display.

### SUMMARY OF THE INVENTION

A method and system of the present invention are distinguished by the fact that graphical elements can be displayed to a communication partner to enhance communication beyond words and synthesized speech. Extensive research in the field of augmentative communications has focused on using graphical elements, such as pictures and icons, to help a non-vocal user encode a message quicker than typing it letter-by-letter. But in spite of the well-known axiom “a picture's worth a thousand words”, none of these techniques have thought to use pictures, animations, video, or other graphical elements to output the message as well. The present invention corrects this oversight by providing two touch-sensitive, graphical, dynamic displays: one for the operator and one for the interlocutor (communication partner).

The operator interacts with an Operator Display to compose a message. They may interface with the Operator Display through a number of different methods, depending on their physical ability. For example, a message could be composed by touching elements on the display, scanning the elements on the display using a switch, or selecting them using a head pointing device. A composed message could include text, speech, graphical elements, or any combination thereof.

For example, imagine someone approaching an AAC user, asks them “How are you feeling?” A typical response using today's devices would be a verbal-only reply in a synthesized voice stating “I feel fine.” Now imagine the same scenario with a dual-display graphical device: the AAC user could answer “Great!” while simultaneously displaying text and an animation of a figure jumping up and kicking his heels together. Clearly, a much richer message is conveyed in the second scenario, but with fewer words.

A further advantage is obtained for the present invention through the fact that with a partner display, communication can remain face-to-face. The communication partner will be more likely to focus on the output of the message, facing the operator, rather than its composition, when they have a display facing them for that purpose.

In another aspect, the Partner Display is interactive through the use of a touch-screen. In the cases where the non-vocal operator is also deaf, the communication partner can compose messages of their own that can be presented to the primary operator on the Operator Display.

The interactive aspect of the Partner Display can also be used for other important tasks. For example, a communication partner could select the topic of conversation from the Partner Display thus helping the operator to quickly access the appropriate communication screens. In another example, the communication partner can use the interactive Partner Display to play games while remaining “face-to-face” with the operator.

For a fuller understanding of the nature and advantages of the invention, reference should be made to the ensuing detailed description taken in conjunction with the accompanying drawings.

### BRIEF DESCRIPTION OF THE DRAWINGS

The embodiments of the present invention are described in detail below with reference to the following drawings:

FIG. 1 is a perspective view of a preferred embodiment of the present invention showing an Operator Display and a Partner Display.

FIG. 2 is a hardware block diagram showing the typical hardware components of a system which embodies the method of the present invention.

### DETAILED DESCRIPTION OF THE PREFERRED EMBODIMENT

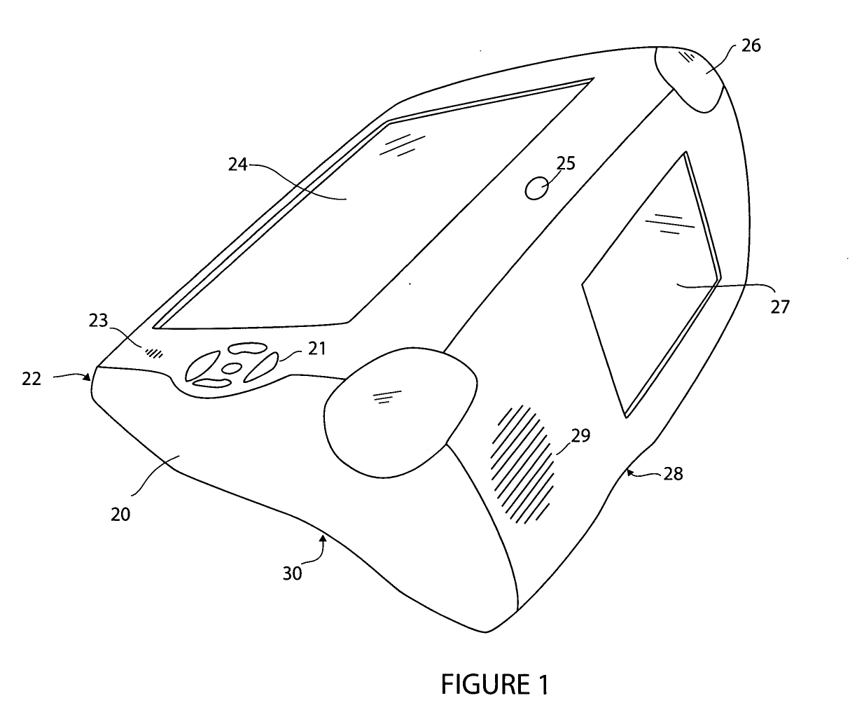

FIG. 1 shows a perspective drawing of a preferred embodiment of the invention; a computing device 20 equipped with an operator display 24 and a partner display 27 both of which allow for human interaction via separate touch-sensitive panels. A primary operator interacts with the device 20 via the touch-sensitive display 24, the built-in keys 21, or through integrated specialized accessibility interfaces. These accessibility interfaces include joystick and switch interfaces 30 located on the underside of the device, or a built-in head pointing system 25. Cabling for the peripherals connected to the various interfaces of the device are routed under the device via a groove 28, thus allowing the device to rest flat on the supporting surface with the cables running beneath it. The operator composes a message using software contained in the memory of the device 20 on the operator display 24. Audible cues are provided by the software to the operator and are delivered via an operator speaker 23. Once the message is ready for publication, the operator causes it to be displayed to the interlocutor, or communication partner, on the partner display 27. The message may also be verbally spoken using synthesized or digitized speech delivered via a partner speaker 29.

Both the operator display 24 and the partner display 27 are capable of displaying graphics. Graphics such as pictures and icons may be used on the operator display to help speed composition of the message. Graphics such as pictures, icons, animations, photographs, and video may be output on the partner display to enhance the message being conveyed to the interlocutor.

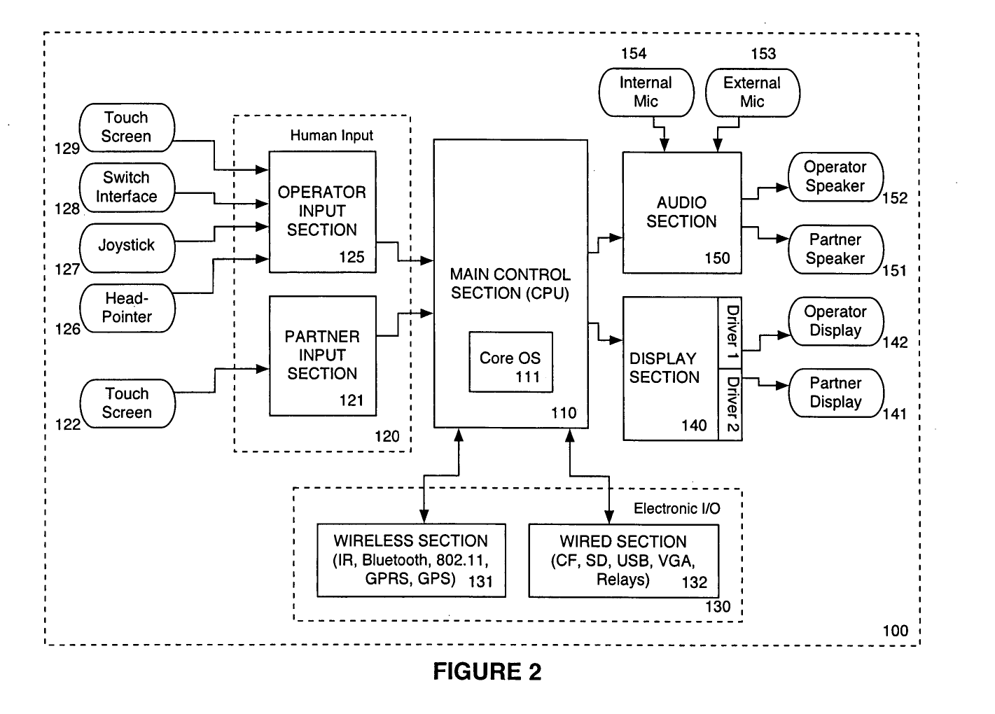

FIG. 2 shows a simplified block diagram of the hardware components of a typical device 100 in which the Dual Display Computing System is implemented. The device 100 includes a human interface section 120 that permits user input from a touch-screen 129, a switch interface 128 (which includes input via the built-in buttons), a joystick interface 127, and a head-pointer interface 126, which provide operator input to a CPU (processor) 110 notifying it of user events typically mediated by a controller 125 that interprets the raw signals received from the input devices and communicates the information to the CPU 110 using a known communication protocol via an available data port. Similarly, the device 100 includes a second touch-screen 122 which provides communication partner input to the CPU 110 notifying it of partner events.

The CPU 110 communicates with a display controller 140 to generate images for an operator display 142 or on a partner display 141. An operator speaker 152 is also coupled to the CPU 110 through an audio controller 150 so that any appropriate auditory signals can be passed on to the user as guidance. Similarly, a partner speaker 151 is coupled to the CPU 110 though a controller 150 so that messages prepared by the operator can be passed on to the communication partner. The CPU 110 has access to a memory (not shown), which may include a combination of temporary and/or permanent storage, and both read-only and writable memory (random access memory or RAM), read-only memory (ROM), writable non-volatile memory such as FLASH memory, hard drives, floppy disks, and so forth.

The audio controller 150 controls audio input from an internal microphone 154 or optionally, and external microphone 153. Audio received by the device 100 through either microphone 153 or 154 may be used to command the device 100, may be recorded and stored, or may be used for real-time processing such as during a telephone conversation.

An electronic input/output component 130 provides several interfaces between the CPU 110 and other electronic devices with which the device 100 may communicate via either a wireless connection 131 or a wired connection 132. The wireless connection 131 includes at least one of five separate industry-standard means for wireless communication: Infrared (input and output), Bluetooth radio, 802.11 radio, GPRS radio for mobile phone capabilities, and a Global Positioning System (GPS) radio. The wired connection 132 includes at least one of five separate industry-standard means for wired input and output: a Compact Flash (CF) slot, a Secure Digital (SD) slot, Universal Serial Bus (USB) host and client, VGA video port, and relay switch outputs. The VGA port may be set by the operator to mirror the output of either the operator display or the partner display.

In another aspect, two separate channels of audio accompany the two separate displays. When an operator is composing a message, it is common for software executed by the CPU 110 to provide audio signals that provide confirmation back to the operator. These audio signals are passed through to the operator speaker 152, which is directed toward the operator and is typically set to a lower volume level since the device is in close proximity to the operator. Additionally, audio that accompanies the outputting of a message is passed through to the partner speaker 151, which is directed toward the communication partner and typically set to a higher volume level so the message can be clearly heard by a person nearby.

Alternatively, the operator audio can be passed through the wireless connection 131 to a wireless headset worn by the operator, such as BlueTooth-equipped headsets commonly used in conjunction with cellular telephones. Yet another alternative is for the operator audio to be passed through to a wired headset or speakers which may be mounted near the operator's head. Finally, the partner audio may likewise be passed through to external speakers (wired or wireless).

The ability to have two separate audio channels that coincide with the dual display aspect of the invention allows sounds intended only for the operator to be kept relatively private as the operator composes a message on the operator display 142, helping to ensure the communication partner is not distracted by the device during composition time. Further, having each speaker 152 and 151 near the corresponding display 142 and 141, and separately oriented toward the operator and communication partner, provides a more natural interaction between the device and the humans on either side.

In another aspect, the partner display 141 is equipped with a touch screen 122 to provide interaction between the partner and the device. For example, an operator may display a list of conversational topics on the partner display 141, one of which could be “Where do you live?” When a communication partner selects that item by touching the partner display 141, a pre-stored message could be displayed and verbalized. The message may include of a synthesized voice reading the operator's address out loud via the partner speaker 151, the device 100 displaying the written address on the partner display 141, and/or the device 100 displaying a map indicating directions to the operator's home on the partner display 141. To compose and output that amount of information would typically take an operator of the device 100 a considerable amount of time. By providing the touch screen interface on the partner display 141 and allowing the partner to interact with the device 100 directly can help to significantly speed the process of communication.

In another aspect, graphical elements may be displayed on the partner display 141 to enhance the meaning of a given message. In a conventional social interaction between two persons sharing a conversation, many aspects besides the spoken word are used to convey information, emotion, and meaning. For example, facial expressions, gestures, body language, and sounds, which are not words, can all be used to greatly add meaning to the conversation. In the present invention, pictures, icons, colors, photographs, animations, video, and other graphical elements may be used to enhance the message.

In the present invention, a short video clip, perhaps of a well-known actor, could be output to the partner display and speaker that would request the attention of the partner: “Excuse me—I'd like your attention for a moment please”. The combination of video and audio of a real person speaking has a profoundly more positive effect on perspective communication partners than can be achieved with synthesized speech alone.

Similarly, pictures can convey meaning in a single glance that may require several words or sentences to verbalize. Pictures and other graphical elements can speed the process of composing and outputting a message in the present invention, since there is a second display on which to present them.

In another aspect, the two displays may be made to simultaneously display the same information. In this regard, the partner display 141 may be set to “mirror” the operator display 142. This is useful, for example, in learning situations where a therapist is helping to train a new AAC operator. With conventional single-display systems, the therapist is required to stand or sit behind the operator to see their interaction with the system. This results in a loss of face-to-face interaction and can be physically uncomfortable for the therapist. In this mode, the therapist can remain facing the operator, yet see what the operator is doing via the partner display 141.

In another aspect, the video signal of either display 141, 142 may be output to a VGA monitor via the wired connection 132. When the device 100 is set to output the contents of the operator display 142, trainers can show large groups how to use the device by connecting it to commonly-available video projectors. Similarly, with the device set to output the contents of the partner display, an AAC operator may “speak” to a large audience by the same means.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

1. An electronic device having two displays capable of displaying both text and graphics, one oriented toward the operator (“operator display”) and the other toward a communication partner (“partner display”).

2. The electronic device of claim 1 where the operator display is equipped with a touch-sensitive input panel.

3. The electronic device of claim 1 where the partner display is equipped with a touch-sensitive input panel.

4. The electronic device of claim 1 where the operator display is capable of displaying video.

5. The electronic device of claim 1 where the partner display is capable of displaying video.

6. The electronic device of claim 1 where the operator display orientation is fixed.

7. The electronic device of claim 1 where the operator display orientation is adjustable.

8. The electronic device of claim 1 where the partner display orientation is fixed.

9. The electronic device of claim 1 where the partner display is adjustable.

10. The electronic device of claim 1 where text is displayed on the partner display to facilitate communication between the operator and the communication partner.

11. The electronic device of claim 1 where graphical elements are displayed on the partner display to facilitate communication between the operator and the communication partner.

12. The electronic device of claim 1 where the two displays may synchronously display the same elements.

13. The electronic device of claim 1 where the two displays may independently display different elements.

14. The electronic device of claim 1 where the operator composes a communication message on the operator display by interacting with onscreen keyboards containing letters.

15. The electronic device of claim 1 where the operator composes a communication message on the operator display by interacting with onscreen keyboards containing graphical elements.

16. The electronic device of claim 1 where the operator interacts with the device by touching the screen of the operator display.

17. The electronic device of claim 1 where the operator interacts with the device through a switch interface.

18. The electronic device of claim 1 where the operator interacts with the device through the use of a mouse pointing device.

19. The electronic device of claim 1 where the operator interacts with the device through the use of a joystick pointing device.

20. The electronic device of claim 1 where the communication partner interacts with the device by touching the screen of the partner display.

21. The electronic device of claim 1 having two separate audio channels, one intended for the operator and the other intended for the communication partner and that correspond to the operator display and partner display.

22. Claim 23 where the device is equipped with two audio speakers, one oriented toward the operator and the other toward a communication partner.

23. Claim 23 where audible sounds, including synthesize and digitized speech can be played separately and individually on the two audio speakers.

24. Claim 23 where audible sounds, including synthesize and digitized speech can be played synchronously on the two audio speakers.

25. Claim 23 where the two separate audio channels are output wirelessly by a radio signal.

26. Claim 23 where the two separate audio channels are output to wired external speakers.

27. Claim 23 where the device is used to communicate for a person unable to speak using their own voice.
